(19) United States
(12) Patent Application Publication
(10) Pub. No.: US 2003/0041495 A1
(43) Pub. Date: Mar. 6, 2003

(54) Color-coded slide holder

(76) Inventor: Hugh D. Mason, Attleboro, MA (US)

Correspondence Address: Dike Bronstein, Roberts & Cushman, Intellectual Property Practice Group, Edwards & Angell, LLP, P. O. Box 9169, Boston, MA, 02209, US

(21) Appl. No.: 10/206,419

(22) Filed: Jul. 25, 2002

Related U.S. Application Data
(60) Provisional application No. 60/316,196, filed on Aug. 30, 2001.

(51) Int. Cl. G09F 3/18

(52) U.S. Cl. 40/642.02

(57) ABSTRACT

A medical information holder is provided. The holder includes a first and a second piece, wherein the pieces are coupled together via a joining means that is color-coded in order to immediately and unmistakably convey information regarding the contents of the holder.

### FIELD OF THE INVENTION

The present invention relates to holders for medical information. More particularly, the present invention relates to microscope slide holders that are color-coded to provide a clear, instantaneous, unmistakable and non language-dependent indication of source, origin, destination, purpose and/or priority level of the slides held therewithin.

### BACKGROUND OF THE INVENTION

The diagnosis, treatment and management of medical patients are extremely difficult, personnel-driven processes. They necessarily involve the interaction and interrelation of numerous individuals, many of whom (e.g., doctors, residents, nurses, physicians assistants) see and communicate with the patients, but still others (e.g., laboratory personnel and health maintenance organization representatives) that rarely, if ever, meet the patient firsthand.

Perhaps the single factor that most greatly inhibits the seamless functioning of these processes is when a mistake is made by one of these many people prior to, during, or following treatment of a patient, but is not immediately discovered by either that or another individual. Such mistakes can have minimal consequences (e.g., wasted time and money to rectify the mistake once made), or more serious ramifications (e.g., short or long term negative influencing of the health of the patient).

Even in instances where such mistakes are discovered, however, the time it takes to rectify them burdens these individuals, each of whom is already faced with crowded schedules that, in many instances, routinely involve situations in which life-savings decisions need to be made.

While such mistakes are difficult to avoid in all aspects of patient care, one area that is especially fertile ground for such errors to occur is the transitioning of microscopic slides to and from the laboratories (“labs”) where the slides are analyzed/tested. Such labs are almost always remotely located from medical treatment facilities, a fact that alone provides opportunities for error(s). Such opportunities are compounded, however, because the slides, during their journey, tend to be handled by many different people, and because the slides, to the naked eye, are highly visually similar to each other, regardless of the actual purpose of the slides, the samples contained on the slides, and/or the patients from whom the samples were taken.

Perhaps realizing this, those in the art began to place microscopic slides in holders/folders in an effort to at least curb the number of errors occurring as a result of slide mishandling. Generally, slides are placed into these holders, which are then labeled with text-based information (e.g., information pertaining to the patient as well as to the source and destination of the slides) to facilitate the direction of the holders to and within a lab, to any other intermediate locations, and then to their ultimate destination following testing/analysis.

These holders have been widely adopted by most medical treatment facilities. Unfortunately, the widespread usage of such slide holders has actually detracted from their utility. Now, so many holders from so many different medical facilities are being used for so many different purposes and are going into and out of so many laboratories or other testing facilities on a daily basis that the sheer volume of holders, coupled with the aforementioned personnel time limitations involved, has hampered the ability of the holders to effectively designate source and/or patient information.

Therefore, a need exists for a microscopic slide holder that allows slides to be routed to and from laboratories or other testing settings such that the holders require minimal attention from all parties involved, but also such that usage of the holders ensures that the entire slide routing, testing, and analysis process is substantially free from errors.

It is therefore an object of the invention to provide microscopic slide holders that can instantly and unmistakably convey information about the contents and/or destination and/or origination and/or purpose and/or priority of the slides contained therewithin.

It would also be desirable to provide microscopic slide holders that include a predetermined identification scheme that is readily understandable by all personnel who come in contact with microscopic slides.

It is also well known that research departments and hospital laboratories function on tight operating budgets. However, they must use slide holders to transport medical information to other departments and laboratories, which then fail to return the holders to the original department or laboratory. Thus, the departments and laboratories from which the holders originate are concerned maintaining their supplies and stocks of slide holders. Thus, it would be useful if the origin of the slide holders could be readily designated and visually displayed.

It would further be desirable to provide such microscopic slide holders having such an identification scheme, which is readily understandable by all personnel regardless of their level of medical training and/or the language they speak or read.

It is also desirable to provide such microscopic slide holders having such an identification scheme, which is visually prominent and recognizable regardless of the vantage point and viewing distance of a viewer, and regardless of the orientation of the holders.

### SUMMARY OF THE INVENTION

These and further and other objects and features of the invention are apparent in the disclosure, which includes the above and ongoing written specification, with the claims and the drawings.

The invention relates to a method of conveying information regarding contents of a medical information holder, comprising the steps of: determining a designation pattern wherein information relating to the contents of the holder is matched to a color-based identification scheme; allowing at least some personnel who come into contact with the holder to become familiar with the color-based identification scheme; and providing a medical information holder, at least a portion of which is color-coded in accordance with the color-based identification scheme. The color-based identification scheme conveys information selected from the group consisting of the origin of the contents of the holder, the destination of the contents of the holder, the test to be performed on the contents, the priority at which the tests are to be performed, and combinations thereof. Preferably, the contents of the medical information holder include at least one microscopic slide.

In the methods of the present invention the color-based identification scheme is based at least partially upon the shade of the color of the holder. The color-coding of the holder is visible by a viewer regardless of vantage point of the viewer.

The present invention also relates to a color-coded medical information holder, comprising: a first piece; a second piece, wherein a top face of the second piece includes at least one holding area for medical information; and joining means for coupling the first piece to the second piece, the joining means being color-coded in accordance with a predetermined color-based identification scheme so as to be effective to convey predetermined information about the medical information. In preferred holders, the medical information comprises microscopic slides, X-rays or other medical specimens.

Another embodiment of a color-coded medical information holder of the present invention comprises: a first piece; a second piece, wherein a top face of the second piece includes at least one holding area for medical information; and joining means for coupling the first piece to the second piece, wherein the first piece, second piece and/or the joining means is color-coded in accordance with a predetermined color-based identification scheme so as to be effective to convey predetermined information about the medical information.

Although the present invention is primarily described herein as being applicable as a holder for microscopic slides, it has numerous other uses, including, but not limited to, application as a holder or containment unit for other medical information, such as x-rays.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views, and wherein:

FIG. 1 is a schematic view of a slide holder in a partially open position in accordance with the present invention; and

FIG. 2 is a side view of the slide holder of FIG. 1 in a closed position.

### DETAILED DESCRIPTION OF THE INVENTION

The invention provides a novel holder for medical information (e.g., microscope slides), wherein the holder is color-coded to designate one or more pieces of information relating to the contents of the holder. Incorporation of this color-coded identification scheme into such holders allows them to more immediately and unmistakably convey information regarding their contents, and/or origination or destination, as compared holders that include entirely text-based identification schemes.

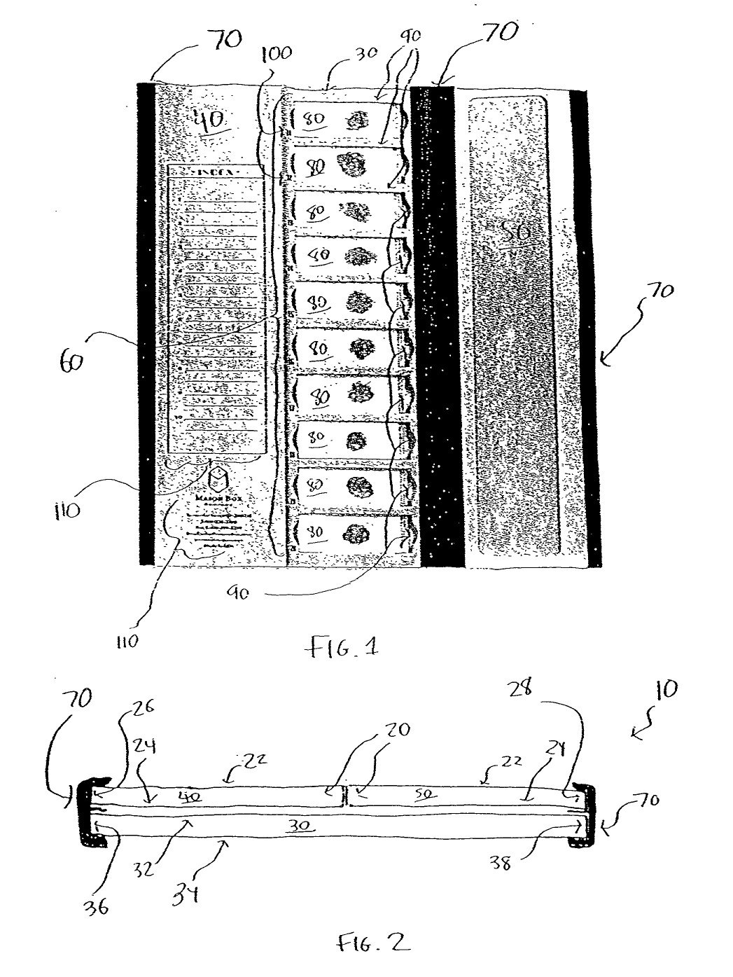

As shown in FIGS. 1 and 2, an exemplary holder 10 comprises first and second pieces 20, 30, wherein the first piece 20 is divided into first and second flaps 40, 50, one or both of which can be completely or partially opened (see FIG. 1) to reveal a slide holding portion 60 of the second piece.

Each of the first piece 20 and the second piece 30 of the holder 10 includes a top face 22, 32, a bottom face 24, 34 and two sides 26, 28 and 36, 38. The pieces 20, 30 are coupled together via a joining means 70 that is effective to allow the holder 10 to assume a closed position wherein both flaps 40, 50 of the top face 22 are directly atop the top face 32 of the second piece 30, and partially or entirely open positions wherein one or both of the flaps have been opened (i.e., lifted from their closed position) in order to reveal and gain access to the slide holding portion 60 of the top face of the second piece.

In an exemplary embodiment of the present invention, a joining means 70 is bound or otherwise caused to attach/adhere to each of the faces 22, 24, 32, 34 of the pieces 20, 30 of the holder such that the joining means surrounds each side 26, 28, 36, 38 of the pieces, but also such that the joining means is visible from any vantage point—that is, such that at least part of the joining means is visible if the flaps 40, 50 of the holder 10 are closed, partially open or entirely open, if the holder is placed on a shelf or a flat surface, and if other objects have been placed on top of, below, and/or to the sides of the holder.

The joining means 70 can be made of any flexible material that is adhesive (or can be made to be adhesive) and that is available in a wide array of colors (or that is receptive to being colored). Exemplary joining means 70 are made of materials including, but not limited to fabric, plastic, tape, mesh, paper, reinforced paper, combinations thereof, and other materials or combinations of materials known in the art that have properties similar to one, some or all of these exemplary materials. Currently, the joining means 70 is preferably made of a colored binding material.

The specific dimensions of the holder 10 and the material(s) from which it is made may vary, as can the number of slides it is capable of holding. Exemplary materials from which the holder 10 may be made include, but are not limited to, paper, plastic, wood, and, preferably, cardboard (e.g., heavy gauge cardboard). The dimensions of the holder 10 may be readily selected by one of ordinary skill in the art based upon the size and/or number of slides to be held therewithin. An exemplary holder 10 of the present invention is about 13.5 inches long, about 8.5 inches wide, and about 0.35 inch high.

The holder 10 includes a predetermined number of slide compartments 90, each of which is capable of holding a microscopic slide 80. The holder 10 generally holds in the range of about 1 to 30 slides, preferably about 1 to 20 slides, most preferably about 20 slides. Generally, each slide component 90 is identified by one or more indicia 100 (e.g., one or more numeric identifiers).

The holder 10 can include other identifying indicia as well. For example, the top face 22 of the first piece 20 generally includes areas 110 where information can be written/typed regarding the slides. Similar information can be included on other areas of the holder 10 as well, e.g., the bottom face 24 of the first piece 20, and the bottom face 34 of the second piece 30.

In a preferred embodiment of the present invention, one or more pieces of information about the slides is/are conveyed based on the color(s) and/or shades of color(s) of the joining means 70.

Exactly which and how many pieces of information is/are conveyed by the color of the joining means 70 are based on a predetermined matching/designation pattern. For example, the pattern may designate that a color only conveys one piece of information (e.g., that the slides are from a particular hospital, or that the slides are to be delivered to a particular laboratory for testing, or that the slides are to be routed to a particular department of a laboratory, or that the slides are from a particular laboratory, or that the slides are high priority slides that should receive immediate attention).

Alternatively, the pattern may designate that a single color may convey multiple pieces of such information and/or that a dark shade of a particular color can convey different information than a light shade of that color. Moreover, the joining means 70 may be multi-colored and/or multi-shaded, wherein each color and/or shading conveys different information in accordance with the matching/designation pattern.

Individuals who come into contact with the holders 10 can be trained to recognize (or to otherwise familiarize themselves with) the pattern and, thus, what is signified by each particular color, shade, and/or combination of colors. Such training can be repeated and revisited as many times as is necessary in order to reliably ensure such that all individuals (regardless of their level of medical training) can instantly and unmistakably recognize the information conveyed by a particular color, combination of colors, or color shading.

The information conveyed by a color, combination of colors, and/or color shading can include, but is not necessarily limited to, the origin and/or destination of the folder, the type of test(s) to be performed on the slides contained therewithin, the priority level for the testing, and even the patient(s) from whom the samples on the slides were taken.

This color-coded identification scheme is advantageous as compared to text-based identification schemes. For example, colors can be viewed and discerned from farther distances that text-based identification schemes. Moreover, because the coloring preferably spans the entire joining means 70, the color can be noticed regardless of the vantage point of the viewer, regardless of whether the holder 10 is closed, partially open or entirely open, regardless of whether the holder is placed on a shelf or a flat surface, and regardless of whether other objects (e.g., other slide holders) have been placed on top of, below, and/or to the sides of the holder. Also, colors transcend languages, thus making it easier for those who speak/read different languages to be able to reliably discern information about the holders.

In an alternate embodiment of the present invention, other components of the holder 10 in addition to or in lieu of the joining means 70 may be color-coded in order to provide further/alternate information regarding the slides 80 contained therewithin. For example, the entire top face 22 of the first piece 20 of the holder 10 may be color-coded. Alternatively, one or both of the flaps 40, 50 of the top face 20 of the holder may be color-coded.

The invention has been described in detail with particular references to the preferred embodiment(s) thereof. It will be appreciated, however, that modifications and improvements within the spirit and scope of this invention may be made by those skilled in the art upon considering the present disclosure.

What is claimed is:

1. A method of conveying information regarding contents of a medical information holder, comprising the steps of:
determining a designation pattern wherein information relating to the contents of the holder is matched to a color-based identification scheme;
allowing at least some personnel who come into contact with the holder to become familiar with the color-based identification scheme; and
providing a medical information holder, at least a portion of which is color-coded in accordance with the color-based identification scheme.

2. The method of claim 1, wherein the color-based identification scheme conveys information selected from the group consisting of the origin of the contents of the holder, the destination of the contents of the holder, the test to be performed on the contents, the priority at which the tests are to be performed, and combinations thereof.

3. The method of claim 1, wherein the contents of the medical information holder include at least one microscopic slide.

4. The method of claim 1, wherein the color-based identification scheme is based at least partially upon the shade of the color of the holder.

5. The method of claim 1, wherein the color-coding of the holder is visible by a viewer regardless of vantage point of the viewer.

6. A color-coded medical information holder, comprising:
a first piece;
a second piece, wherein a top face of the second piece includes at least one holding area for medical information; and
joining means for coupling the first piece to the second piece, the joining means being color-coded in accordance with a predetermined color-based identification scheme so as to be effective to convey predetermined information about the medical information.

7. A color-coded medical information holder, comprising:
a first piece;
a second piece, wherein a top face of the second piece includes at least one holding area for medical information; and
joining means for coupling the first piece to the second piece,
wherein the first piece, second piece and/or the joining means is color-coded in accordance with a predetermined color-based identification scheme so as to be effective to convey predetermined information about the medical information.
